(19) United States
(12) Patent Application Publication
(10) Pub. No.: US 2017/0231218 A1
(43) Pub. Date: Aug. 17, 2017

(54) Waterfowl decoy with mechanical movement

(71) Applicant: Hayes Brandon Turner, Cabot, AR (US)

(72) Inventor: Hayes Brandon Turner, Cabot, AR (US)

(21) Appl. No.: 15/368,205

(22) Filed: Dec. 2, 2016

Related U.S. Application Data
(63) Continuation-in-part of application No. 14/864,476, filed on Sep. 24, 2015.

(51) Int. Cl. A01M 31/06; B63H 5/02

(52) U.S. Cl. CPC A01M 31/06; B63H 5/02

(57) ABSTRACT

A mechanical waterfowl decoy to be used in water. It has a buoyant body and a motor that rotates a paddlewheel in a circular manner which can provide propulsion and water disturbance for the decoy and can give the appearance of a duck swimming, splashing, and moving its head.

### PRIORITY CLAIM AND INCORPORATION BY REFERENCE

This application is continuation in part of application Ser. No. 14/864,476 filed on Sep. 24, 2015 which is incorporated herein in its entirety and for all purposes.

### BACKGROUND OF THE INVENTION

The present invention is in the technical field of waterfowl decoys. More particularly, the present invention is in the technical field of mechanically operated waterfowl decoys. More particularly, the present invention is in the technical field of mechanically operated waterfowl decoys that have wing movement.

Conventional mechanical waterfowl decoys have mechanical movement of various body parts including the wings. The wing motion of these decoys is often created by a direct connection to a motor.

### SUMMARY OF THE INVENTION

The present invention is a mechanically operated waterfowl decoy, having a paddlewheel, that rotates 360 degrees around a horizontal axis, preferably cycling through the water, through the body of the decoy, striking the underside of the wings, lifting them momentarily to imitate wing flapping of waterfowl.

The advantages of the present invention include, without limitation, that it is relatively simple in mechanical operation. The 360 degree rotation of the paddlewheel may serve as a means of propulsion, allowing it to swim around automatically. The 360 degree rotating paddlewheel may also create a splashing and wing movement unlike that of traditional mechanical waterfowl decoys, particularly those with mechanical moving wings.

In broad embodiment, the present invention is a waterfowl decoy that has a motor driven paddlewheel, that rotates 360 degrees, cycling through the body of the decoy, and preferably the water, striking the underside of the wings, lifting the wings in a natural flapping motion.

### BRIEF DESCRIPTION OF THE DRAWING

These and other features, aspects, and advantages of the present invention will become better understood with regard to the following description, appended claims, and accompanying drawings where:

FIG. 1 is a perspective view of a mechanical waterfowl decoy of the present invention;

FIG. 2 is a perspective view of a mechanical waterfowl decoy of FIG. 1. with portions open to show detail.

FIG. 3 is a side view of a mechanical waterfowl decoy of the present invention;

FIG. 4 is a side view of a mechanical waterfowl decoy of the present invention.

FIG. 5 is a top view of a mechanical waterfowl decoy of the present invention.

FIG. 6 is a bottom view of a mechanical waterfowl decoy of the present invention.

FIG. 7 is a top view of a mechanical waterfowl decoy of the present invention with portions open to show detail.

FIG. 8 is a bottom view of a mechanical waterfowl decoy of the present invention.

FIG. 9 is a perspective view of a configuration of the present invention.

FIG. 10 is a top view of a configuration of a mechanical waterfowl decoy of the present invention with portions open to show detail.

FIG. 11 is a bottom view of a configuration of a mechanical waterfowl decoy of the present invention with portions open to show detail.

FIG. 12 is a perspective view of a configuration of the present invention.

### DETAILED DESCRIPTION OF THE INVENTION

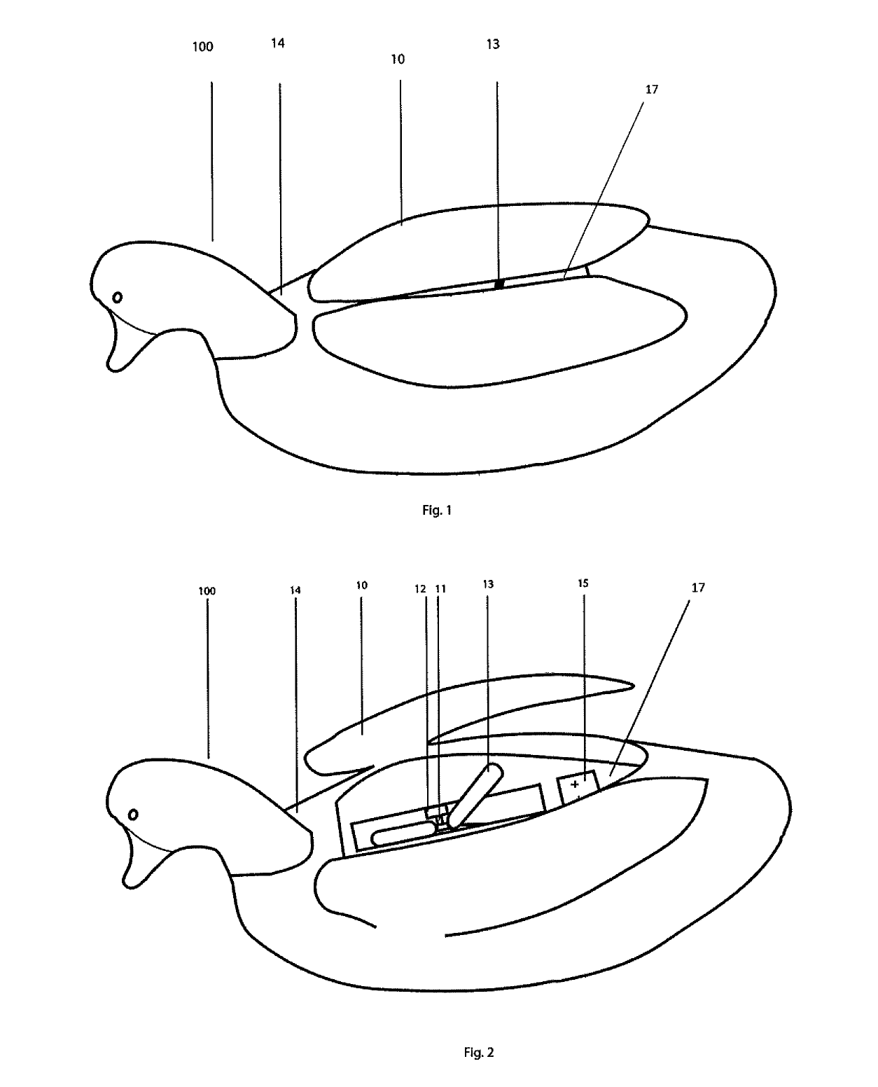

Referring to the drawings, FIG. 1 depicts an embodiment of a mechanical waterfowl decoy 100 having a buoyant decoy body 14 which is open at the top and bottom. 14, having a pair of moveable wings 10 and having a paddlewheel 13.

The buoyant decoy body 14 is sufficiently wide, long, and tall enough for encasing and providing sufficient flotation for the mechanical elements of the mechanical waterfowl decoy 100 and retaining a realistic size of that of any particular waterfowl, in this case, a duck. Sufficient size is between 12 long 20 inches long with a width of approximately 50% of the length and a height approximately equal to the width. The decoy body 14 may be made of plastic or of any other sufficiently rigid material that could be made buoyant such as polystyrene, wood, metal, or composite material and may be of solid or hollow construction.

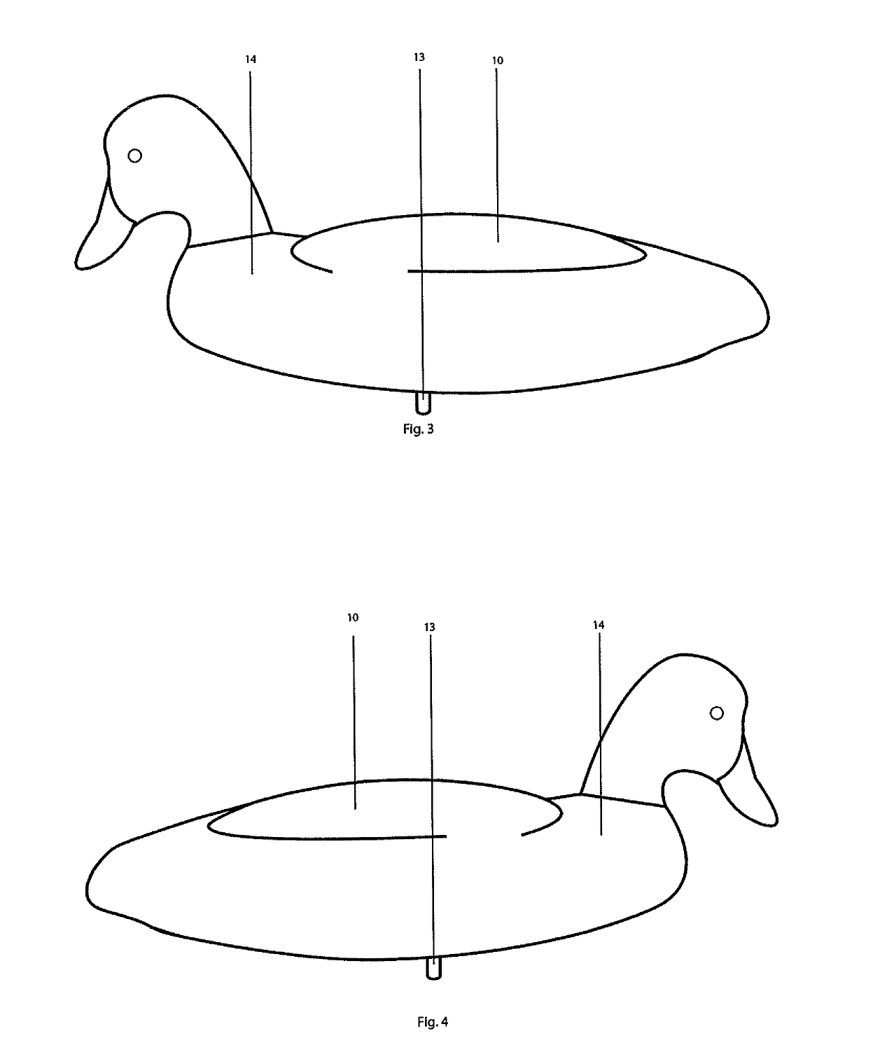

Referring to FIG. 2, the decoy 100 additionally has a shaft 11, which is operated by a motor 12 to turn a paddlewheel 13. The paddlewheel 13 shall have one or more paddles and shall be sized to be partially encased within the open portion 17 of the body 11, with a diameter large enough such that the paddle(s), during rotation, extend above the top of the decoy body and which may extend below the bottom of the decoy body. The paddlewheel may be made or a rigid or semi-rigid material such as plastic, metal, wood, or composite material.

The motor 12 may be removably attached to the decoy body, preferably within the open portion 17 of the decoy body. The motor 12 shall provide a rotational output and may be powered electrically, mechanically, or via steam or internal combustion. The motor 12 may also be connected to a power source 15 to supply the motor with electrical or mechanical power. The power source 15 may be integral to or separate from the motor 12. The power source may be removably attached to the motor 12 or the decoy body 14. The decoy also features a shaft 11 which may be directly connected to the motor 12 or indirectly connected via a belt 16. The shaft shall be made of a rigid material, preferably metal. The belt 16 shall be made of rubber, silicone, plastic or other flexible material.

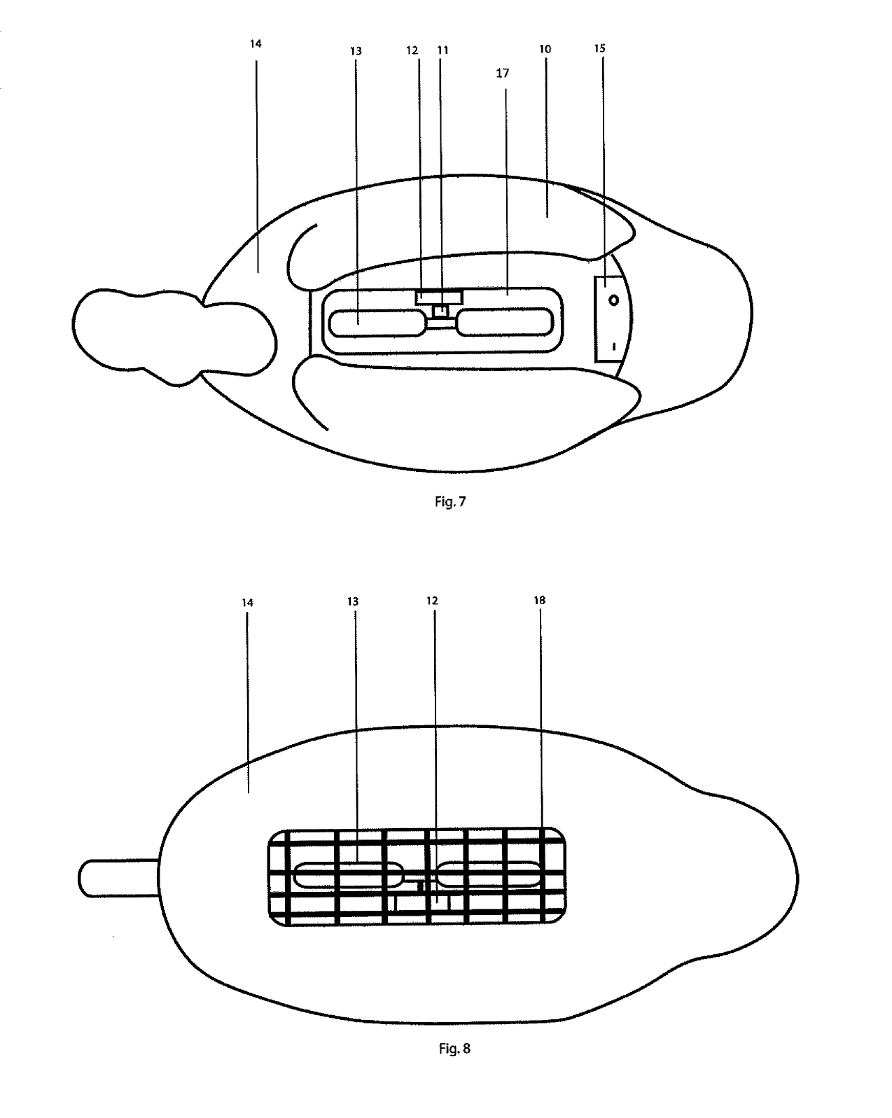

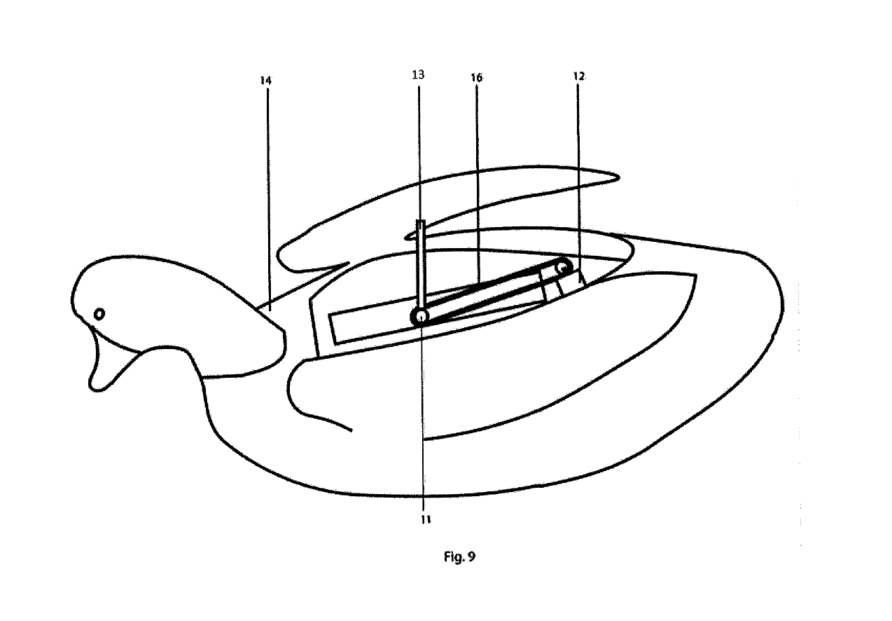

Referring to FIGS. 1-5, 7 and 10, the mechanical waterfowl decoy 100 may feature a pair of movable wings 10 flexibly attached to the decoy body 14. The wings 10 are configured such that they rest on the top of the body 14 of the decoy and mostly cover the open portion 17 of the decoy body. Due to the flexible attachment of the wings 10 to the body 14, the wings may be manually moved to allow access to the open sections of the decoy body 14. The wings 10 may also be removed or omitted to allow unrestricted access to the open portion 17 of the decoy as well as an unrestricted view of the operation of the rotating paddle wheel 13. The wings 10 may be made of a rigid material similar to the construction of the decoy body 14 or may be made or a flexible material such as rubber, silicone, flexible plastic or other flexible material.

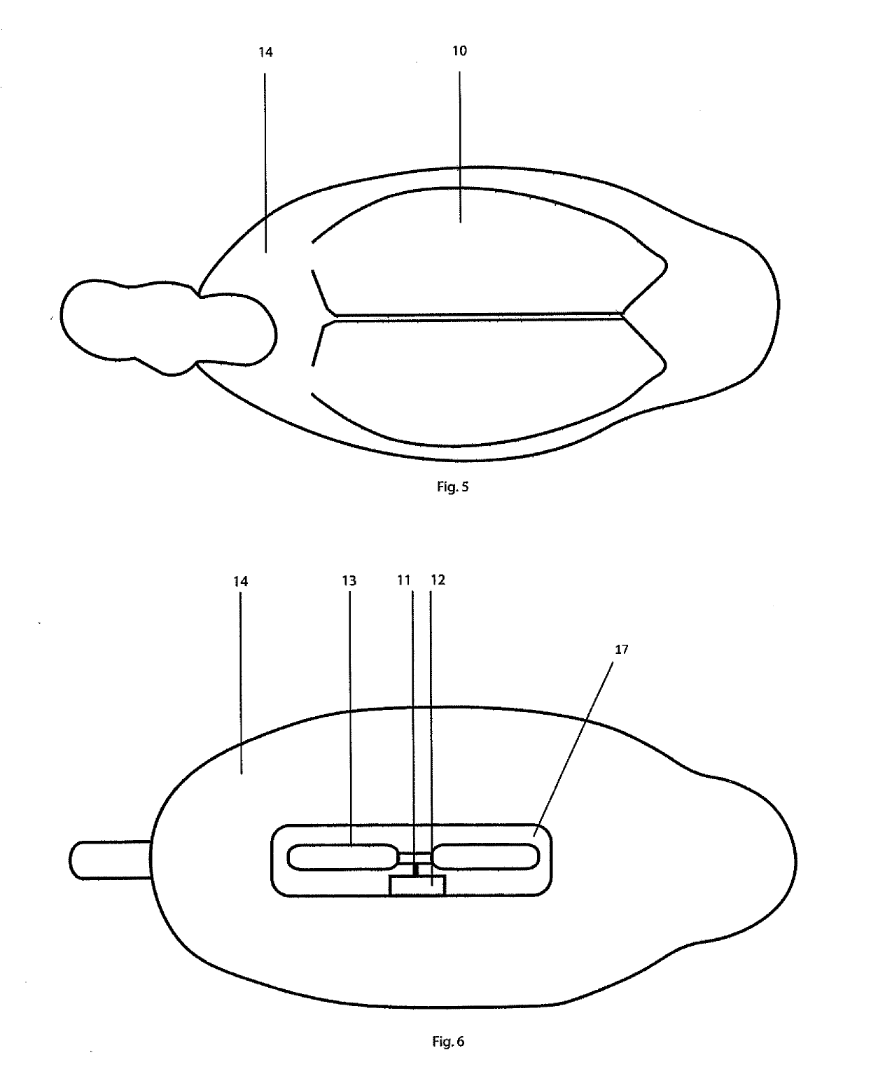

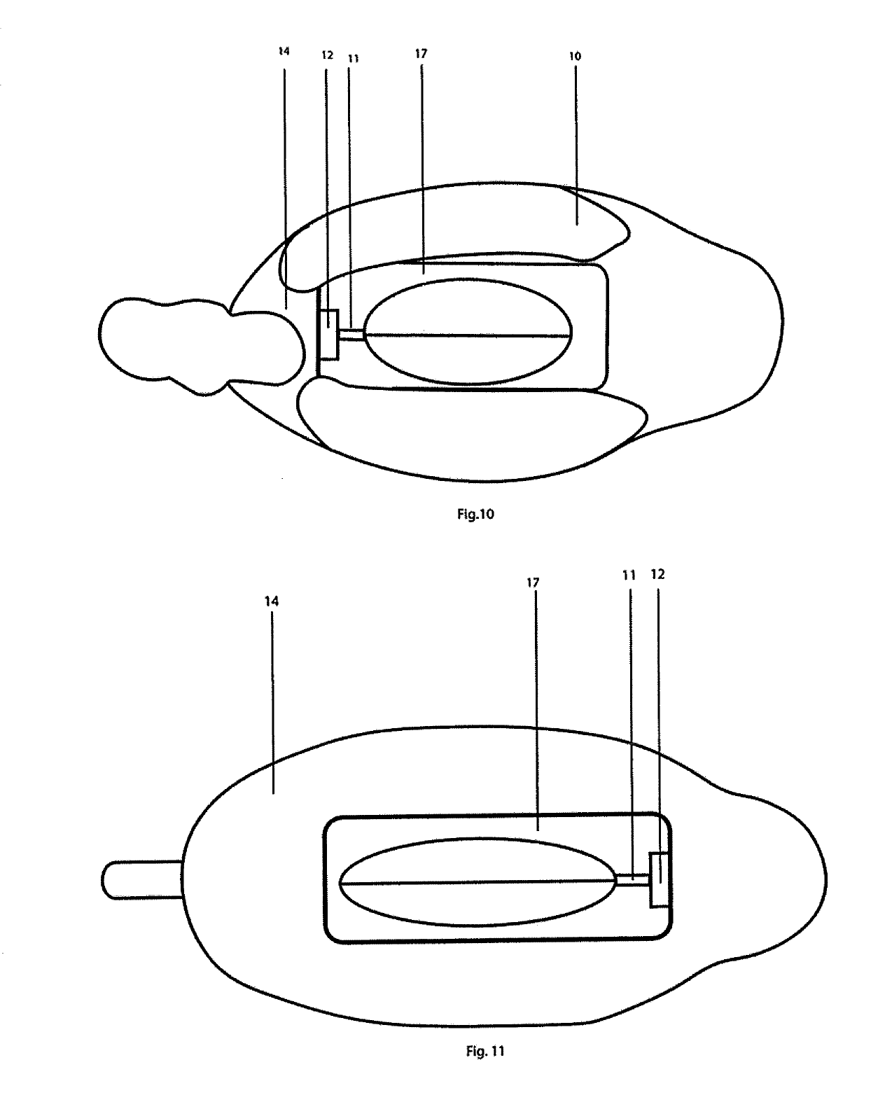

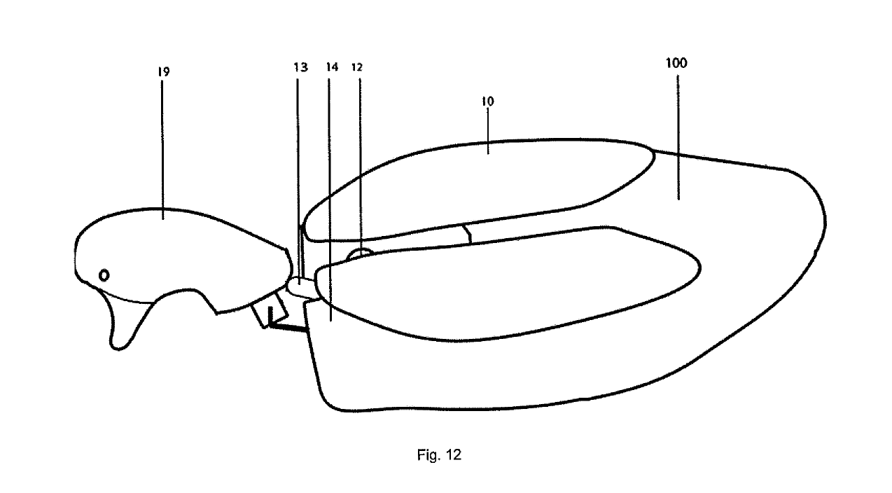

The decoy 100 operates by way of the paddlewheel 13 rotating within the open portion 17 of the decoy body 14 on a shaft 11 which is powered by a motor 12. The motor 12 causes the shaft 11 to rotate which, in turn, causes the paddlewheel 13 to rotate about the shaft. The shaft is oriented horizontally and may be oriented perpendicular or parallel to the longitudinal axis of the decoy 100. FIGS. 2-8 depict a decoy with the shaft 11 oriented perpendicular to the longitudinal axis of the decoy. FIGS. 10-11 illustrate the decoy with the shaft oriented parallel to the longitudinal axis of the decoy. The paddlewheel 13 rotates in a circular motion around the shaft 11.

While the decoy 100 is floating in a liquid, the rotation of the paddlewheel 13 may cause the ends of the paddles on the wheel to pass under the liquid's surface which provides disturbance to the liquid's surface and propel the decoy and passes under the wings to lift them above the decoy body 14 to imitate wing flapping. Further, the rotation of the paddlewheel 13 may cause the ends of the paddles to strike the undersides of the wings 10 and cause them to move and simulate a wing flapping movement. Where the wings 10 are removed or omitted, the rotation of the paddle wheel will be visible from above and may simulate wing movement.

Referring to the drawings, FIG. 8 depicts the decoy 100 with a rigid guard 18 affixed to the underside of the buoyant body 14 which extends downward along the longitudinal axis of the decoy 100 beyond the downward most position of the paddlewheel 13. The rigid guard 18 shall be constructed of plastic, metal or other rigid material and shall be constructed such that a fluid may pass freely through its structure. The rigid guard 18 shall be shaped with a void space sufficient to permit clearance of the paddlewheel 13 during operation of the decoy. The rigid guard acts to prevent obstructions and debris from obstructing the rotation of the paddlewheel 13.

Referring to the drawings, FIG. 12 depicts the decoy 100 with a decoy head 19 which is movably attached to the front of the buoyant decoy body 14 and is positioned such that the paddlewheel 13 may strike the rear of the head 19 during the rotational movement of the paddlewheel 13. The head 19 may be constructed of any rigid or semi-rigid material but it is preferred for the head 19 to consist of the same material as the decoy body 14. During the operation of the decoy, the rotation of the paddlewheel 13 may strike the decoy head 19 which will cause the decoy head to move which may simulate the head movement of waterfowl.

While this invention has been described with the specific embodiments outlines above, the preferred embodiments set forth are intended to be illustrative, not limiting. Various changes may be made without departing from the scope of the invention as defined in the following claims. The claims provide the scope of coverage of this invention and should not be limited to the specific examples cited above.

What is claimed is,:

1. A mechanical waterfowl decoy for placing on the surface of a liquid comprising:
a buoyant decoy body with an open section on the interior of the decoy body;
a paddlewheel located in the open section of the decoy body which is connected to a shaft and configured to rotate in a circular manner around the shaft;
a motor which is connected to said shaft and is configured to rotate the shaft and paddlewheel;
a power source configured to supply power to the motor;
a decoy head which is movably attached to said decoy body and configured to be struck and moved by the paddlewheel.

2. The mechanical waterfowl decoy of claim 1 further comprising a pair of movable wings attached to the decoy body and configured to be struck on the underside and moved by the paddlewheel.

3. The mechanical waterfowl decoy of claim 1 further comprising a rigid guard.

4. The mechanical waterfowl decoy of claim 2 further comprising a rigid guard.

5. The mechanical waterfowl decoy of claim 1, wherein the shaft is connected directly to the output of the motor.

6. The mechanical waterfowl decoy of claim 2, wherein the shaft is connected directly to the output of the motor.

7. The mechanical waterfowl decoy of claim 1, wherein the shaft is connected to the motor via a belt.

8. The mechanical waterfowl decoy of claim 2, wherein the shaft is connected to the motor via a belt.

9. The mechanical waterfowl decoy of claim 3, wherein the shaft is connected directly to the output of the motor.

10. The mechanical waterfowl decoy of claim 4, wherein the shaft is connected directly to the output of the motor.

11. The mechanical waterfowl decoy of claim 3, wherein the shaft is connected to the motor via a belt.

12. The mechanical waterfowl decoy of claim 4, wherein the shaft is connected to the motor via a belt.
